(19) United States
(12) Patent Application Publication
(10) Pub. No.: US 2020/0283153 A1
(43) Pub. Date: Sep. 10, 2020

(54) AIRBAG ASSEMBLIES HAVING GUIDE SLEEVES, AND ASSOCIATED SYSTEMS AND METHODS

(71) Applicant: AmSafe, Inc., Phoenix, AZ (US)

(72) Inventors: Todd Joseph Humbert, Chandler, AZ (US); Daniel Nick Foubert, Maricopa, AZ (US)

(21) Appl. No.: 16/292,222

(22) Filed: Mar. 4, 2019

(51) Int. Cl. B64D 11/06

(52) U.S. Cl. CPC B64D 11/0621

(57) ABSTRACT

Airbag assemblies having sleeves and other flexible guide members and associated systems and methods are described herein. Airbag assemblies configured in accordance with some embodiments of the present technology can include a mounting bracket configured to be attached to a structure in an aircraft, such as a passenger seat back or a partition wall, adjacent to a component, such as a display screen. The airbag assemblies can further include an airbag and a guide sleeve attached to the mounting bracket. The airbag is configured to be inflated from a packed or stowed configuration to a deployed configuration. In the stowed configuration, the sleeve at least partially surrounds the airbag. Inflating the airbag to the deployed configuration causes the sleeve to extend between the airbag and at least a portion of the adjacent component to prevent the component or an associated opening from interfering with proper deployment of the airbag.

### TECHNICAL FIELD

The following disclosure relates generally to airbag assemblies for use in aircraft seating areas and, more specifically, to airbag assemblies having guide sleeves that can facilitate proper deployment of the airbag from a housing or other recess in a seat back or other structure.

### BACKGROUND

Various types of airbags have been used to protect passengers in automobiles, aircraft and other vehicles. Automobiles, for example, typically include airbags that can be stored in the steering column, dashboard, side panel, and/or other fixed locations. During a rapid deceleration event (e.g., a collision), a sensor detects the event and transmits a corresponding signal to an initiation device (e.g., a pyrotechnic device) on an airbag inflator. This causes the inflator to release compressed gas into the airbag, thereby rapidly inflating the airbag to protect the seat occupant from impacting a strike hazard in the occupant's path.

Although airbags that deploy from seat backs and other fixed locations in aircraft can be effective, they can present challenges when they are located near structural features that the airbag could catch on during deployment. Seat backs and partitions in commercial aircraft, for example, often include entertainment modules (e.g., video display screens) in or near the deployment path of airbags, and in some instances these modules could potentially interfere with proper airbag deployment.

### BRIEF DESCRIPTION OF THE DRAWINGS

FIG. 1 is a partially schematic top isometric view of an airbag assembly mounted to a fixed structure in an aircraft seating area, configured in accordance with embodiments of the present technology.

FIG. 2 is a partially schematic isometric view of the airbag assembly of FIG. 1, configured in accordance with embodiments of the present technology.

FIG. 3A is a top isometric view of a portion of the airbag assembly of FIG. 1 in in a first stage of assembly, FIG. 3B is a side view of the airbag assembly shown in FIG. 3A, and FIG. 3C is a side view of the airbag assembly of FIG. 3A in a second stage of assembly, in accordance with embodiments of the present technology.

FIG. 4A is a side view of the airbag assembly of FIG. 1 prior to airbag deployment, FIG. 4B is a side view of the airbag assembly after airbag deployment, and FIG. 4C is a top isometric view of the airbag assembly after airbag deployment, in accordance with embodiments of the present technology.

### DETAILED DESCRIPTION

The present disclosure describes various embodiments of airbag assemblies for use with fixed structures (e.g., seat backs, partitions, etc.) of a vehicle (e.g., aircraft). In some embodiments, the airbag assembly can include an airbag configured to inflate and deploy in front of a seat occupant to provide a cushioning barrier between the occupant and, e.g., a strike hazard. In some embodiments, the airbag assembly is stowed in a portion of a seatback or partition in front of the occupant on an aircraft. A conduit extends from the stowed airbag to an inflator that can be mounted under the seat or in another suitable location. If the aircraft experiences an accident or other significant dynamic event (e.g., a rapid deceleration event) in which the occupant could be thrown forward against a strike hazard, the inflator rapidly releases compressed gas into the airbag via the conduit, causing the airbag to rapidly inflate and deploy in front the occupant.

As described in greater detail below, in some embodiments the airbag assembly includes a mounting structure or member (e.g., a plate, bracket, etc.) configured to be attached to a fixed structure (e.g., a seat back, wall, partition, etc.), an airbag attached to the mounting member, and a sleeve attached to or proximate the mounting member. The sleeve can surround at least a portion of the airbag in the stowed position. During deployment of the airbag, the sleeve can be configured to unravel in a manner that covers an opening, gap or other feature created by an adjacent structure, device or component (e.g., an entertainment module, tray table, etc.) that is adjacent the airbag assembly. Accordingly, the sleeve, and its positioning around the airbag, can prevent the airbag from deviating from the desired deployment path and getting hung up on the adjacent feature during deployment. Stated differently, the sleeve can help ensure that the airbag properly deploys to protect the occupant seated behind the airbag. Although referred to herein as a “fixed” structures for ease of reference, it will be understood that aircraft passenger seats that recline and/or move in other ways are nevertheless “fixed” structures for purposes of the present disclosure.

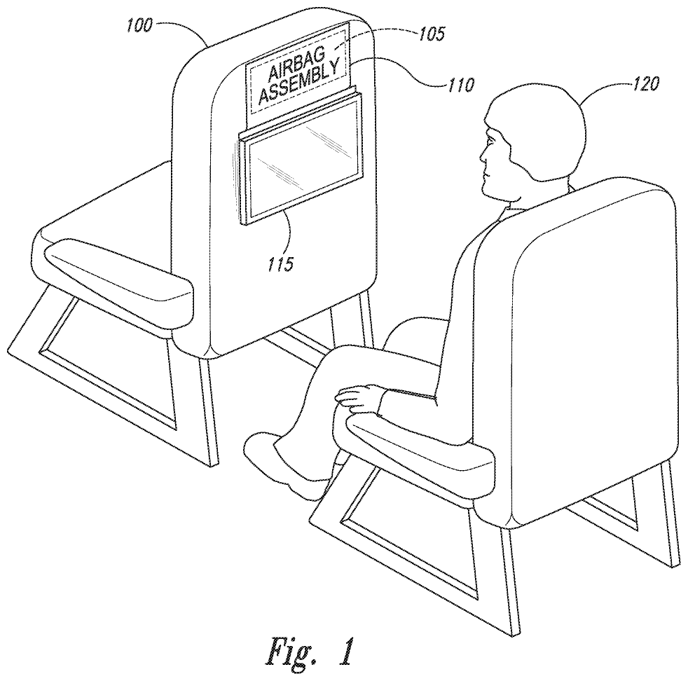

Certain details are set forth in the following description and FIGS. 1-4C to provide a thorough understanding of various embodiments of the disclosure. For example, several embodiments of airbag assemblies are described below in the context of commercial aviation aircraft. However, the airbag assemblies and aspects thereof disclosed herein may be used in a wide variety of other vehicles, including other aircraft (e.g., general aviation and military aircraft), ground vehicles (e.g., automobiles, trucks, buses, trains, and motor homes), watercraft, etc. To avoid unnecessarily obscuring the description of the various embodiments of the disclosure, some details describing well-known structures and systems often associated with airbags, related circuitry, inflators, etc., have not been described in detail below.

Furthermore, many of the details, dimensions, angles and other features shown in FIGS. 1-4C are merely illustrative of particular embodiments of the disclosure. Accordingly, some embodiments can include other details, dimensions, angles and features without departing from the spirit or scope of the present disclosure. In addition, those of ordinary skill in the art will appreciate that further embodiments of the adjustably positionable airbag assemblies disclosed herein can be practiced without several of the details described below.

Throughout this disclosure, the singular terms “a,” “an,” and “the” include plural reference unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the terms “comprising” and the like are used throughout this disclosure to mean including at least the recited feature(s) such that any greater number of the same feature(s) and/or one or more additional types of features are not precluded. Directional terms, such as “upper,” “lower,” “front,” “back,” “vertical,” and “horizontal,” may be used herein to express and clarify the relationship between various elements. It should be understood that such terms do not denote absolute orientation. Reference herein to “one embodiment,” “an embodiment,” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

In FIGS. 1-4C, identical reference numbers identify identical or at least generally similar elements. To facilitate the discussion of any particular element, the most significant digit or digits of any reference number refer to the particular figure in which that element is first introduced. For example, element 110 is first introduced and discussed with reference to FIG. 1.

FIG. 1 is a partially schematic top isometric view of an airbag assembly 105 mounted to a fixed structure 100 in an aircraft seating area, configured in accordance with embodiments of the present technology. As shown in FIG. 1, a rear portion of the fixed structure 100 (e.g., a passenger seat) supports a cover panel 110 (e.g., a flap or door) disposed over the airbag assembly 105, and a component 115 (e.g., an entertainment module, display screen, tray table, etc.) positioned below the airbag assembly 105. The fixed structure 100 can be a passenger seat (as shown in FIG. 1), or other structure such as a wall, partition, etc. in front of or adjacent to a passenger 120 seated behind the structure 100. As described in more detail below, the airbag assembly 105 can be configured to deploy in front of the component 115 to prevent the passenger 120 from striking the component 115 during a crash or other rapid deceleration event.

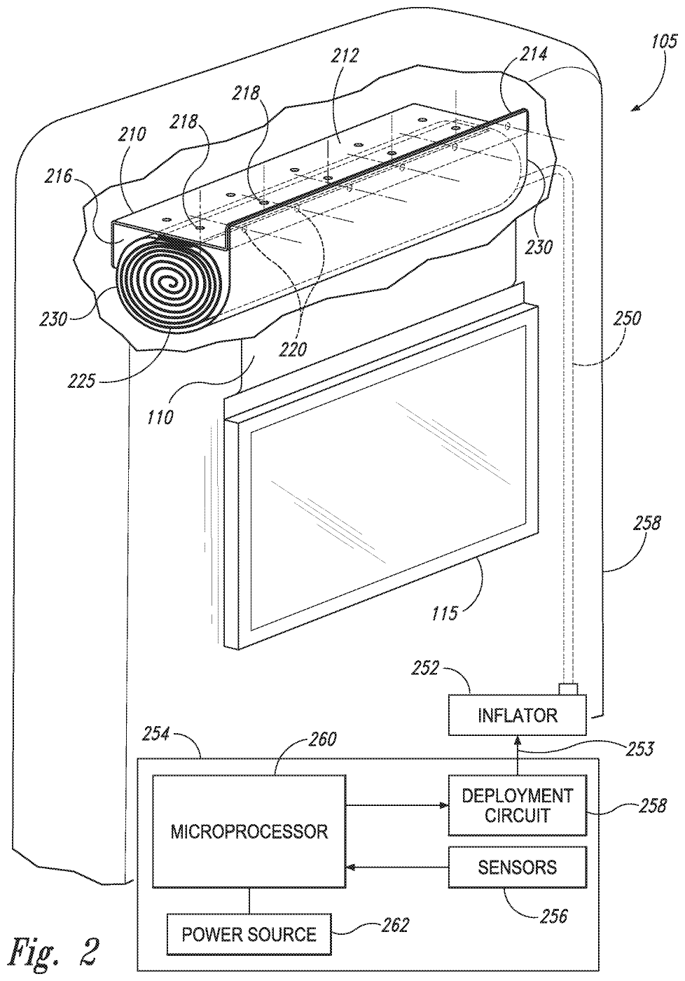

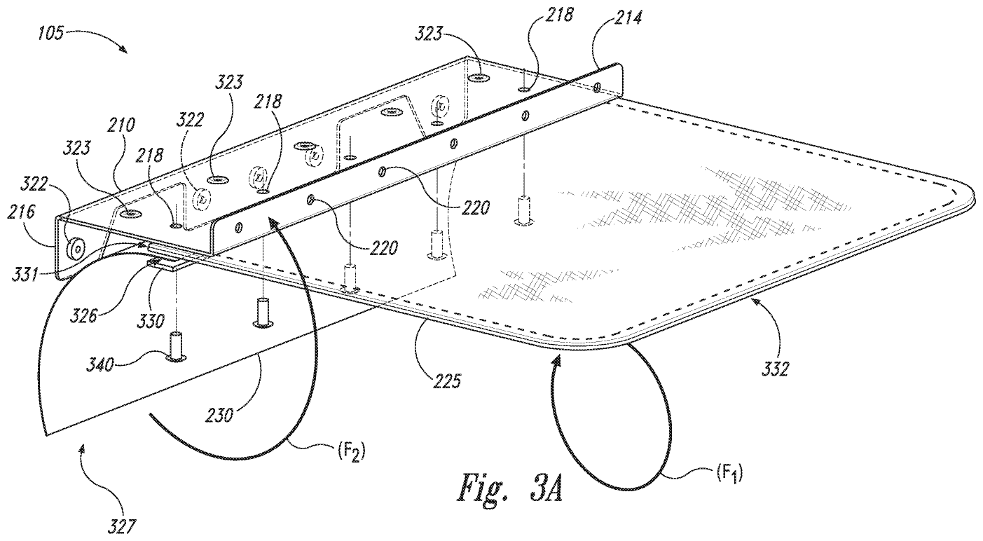

FIG. 2 is a partially schematic isometric view of the airbag assembly 105 of FIG. 1 in a stowed configuration in accordance with embodiments of the present technology. The cover panel 110 and associated hardware has been omitted from FIG. 2 for purposes of illustration. In some embodiments, the airbag assembly 105 is positioned within a recess in the structure 100 above the component 115. The airbag assembly 105 can include a mounting bracket 210, an airbag 225 attached to the mounting bracket 210, and a sleeve 230 surrounding at least a portion the airbag 225. The sleeve 230 can be made of a flexible and/or bendable fabric material (e.g., woven nylon) or other suitable materials known in the art. The mounting bracket 210 can be formed from a suitable sheet metal and can include a plate portion 212, a first flange portion 214 extending upwardly from the plate portion 212 at an angle (e.g., between about 20° to about 160°), and a second flange portion 216 extending downwardly from the plate portion 212 at an angle (e.g., between about 20° to about 160°). The plate portion 212 can include a plurality of first fastener openings 218, and the first flange portion 214 can include a plurality of second fastener openings 220.

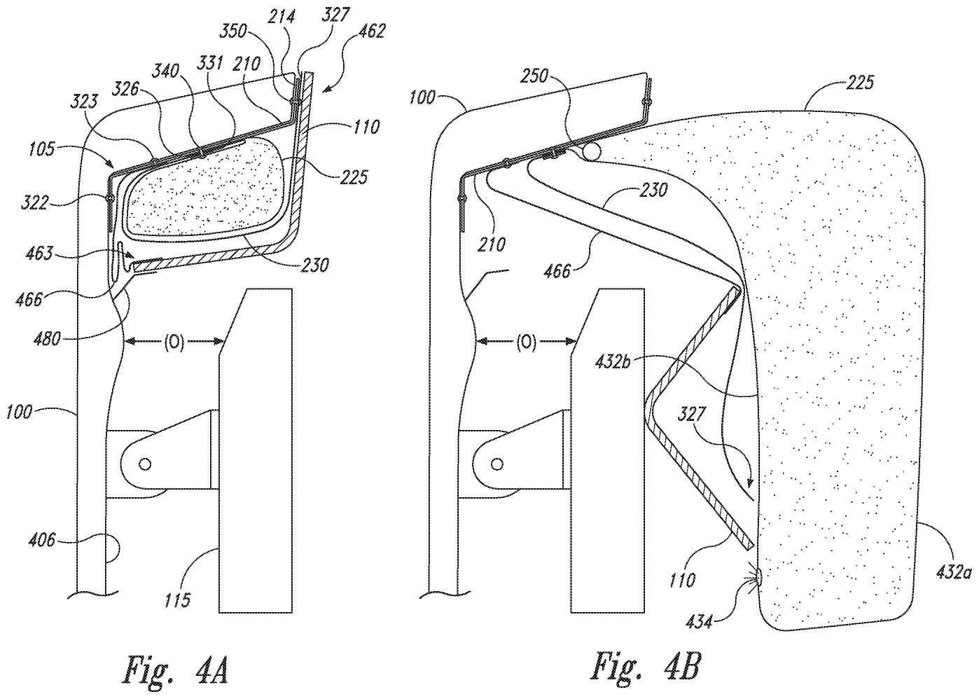

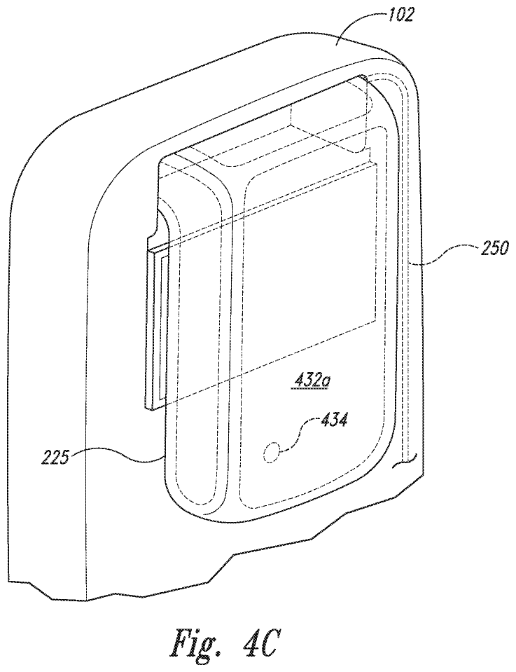

As described in greater detail below, the airbag 225 is configured to be inflated from the stowed configuration shown in FIG. 2 to a deployed configuration as shown in FIGS. 4B and 4C. For airbag deployment, the airbag assembly 105 includes a hose or conduit 250 operably coupled to the airbag 225 and configured to deliver gas thereto. The conduit 250 can include tubing made from stainless steel or another suitable material that enables high pressure gas to flow from an inflator 252 to the airbag 225. In some embodiments, the conduit 250 can be a flexible fabric hose made from nylon or other suitable materials known in the art (e.g., Kevlar, polyurethane, etc.).

In some embodiments, the airbag assembly 105 further includes an electronics assembly 254 (shown schematically) operatively connected to the inflator 252 via a corresponding electrical link 253 (e.g., a wire, electrical line, retractile cord, connector, wireless communication link, etc.). The electronics assembly 254 (e.g., an electronics module assembly (“EMA”)), can include one or more sensor(s) 256 (e.g., a crash sensor, an acceleration sensor, a magnetic field sensor, etc.) and associated devices and circuitry configured to detect a rapid deceleration event above a preset magnitude, and transmit one or more corresponding signals to the inflator 252 via the electrical link 253 to initiate deployment of the airbag 225. During deployment of the airbag 225, high pressure gas flows from the inflator 252 to the airbag 225 via the conduit 250.

The inflator 252 can include a canister, cylinder, and/or other container filled with air or a substantially inert compressed gas (e.g., nitrogen, helium, argon, etc.). The gas can be released by a spike in internal pressure caused by a pyrotechnic, electric, or other initiation device that is activated by an electrical signal from the electronics assembly 254 in response to a crash, rapid deceleration event, or similar dynamic event above a preset level of deceleration. In other embodiments, the inflator 252 can include a propellant-based gas generating device and/or other gas sources suitable for airbag inflation.

As schematically illustrated in FIG. 2, the electronics assembly 254 can include a microprocessor 260 that receives electrical power from a power source 262 (e.g., one or more batteries). The one or more sensor(s) 256 can detect a rapid deceleration event and communicate this event to the microprocessor 260. For example, in operation, when the sensor(s) 256 detects a rapid deceleration or other crash event above a preset magnitude, one or more switches in the sensor(s) 256 can close and cause the microprocessor 260 to send a corresponding signal to a deployment circuit 258. Upon receiving the signal from the microprocessor 260, the deployment circuit 258 transmits a signal to the inflator 252 via the electrical link 253 to initiate deployment of the airbag 225 by discharging gas into the airbag 225 via the conduit 250.

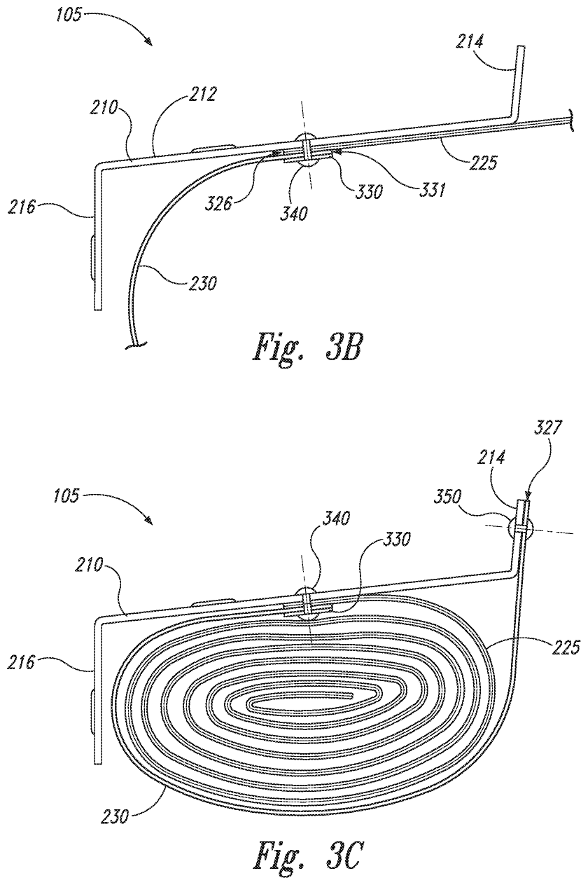

FIG. 3A is a top isometric view of a portion of the airbag assembly 105 of FIG. 1 in a first stage of assembly, FIG. 3B is a side view of a portion of the airbag assembly 105 shown in FIG. 3A, and FIG. 3C is a side view of the airbag assembly 105 in the stowed configuration. In FIGS. 3A and 3B, the airbag 225 is extended generally flat and is not in the stowed configuration. As described above with the reference to FIG. 2, the airbag assembly 105 can include the airbag 225 and the sleeve 230 attached to the mounting bracket 210. As shown in FIG. 3A, the mounting bracket 210 can be attached to the fixed structure 100 (FIG. 1) with a plurality of fasteners 322 (e.g., rivets, screws, etc.) that extend through the second flange portion 216 and a plurality of fasteners 323 (e.g., rivets, screws, etc.) that extend through plate portion 212.

Referring to FIGS. 3A and 3B together, the airbag assembly 105 can further include a cap strip 330 configured to clamp and thereby attach a first end portion 331 of the airbag 225 and a first end portion 326 of the sleeve 230 to the mounting bracket 210. The cap strip 330 can include an elongate plate (e.g., a metal plate) having a plurality of openings along a length thereof. A plurality of fasteners 340 (e.g., rivets, screws, bolts, etc.) or other fixation devices can extend through the openings in the cap strip 330, the sleeve 230, the airbag 225 and the corresponding openings 218 in the mounting bracket 210 to thereby attach the cap strip 330, the sleeve 230 and the airbag 225 to the mounting bracket 210.

After securing the sleeve 230 and airbag 225 to the mounting bracket 210, the airbag 225 can be folded or rolled upon itself in a direction indicated by fold (F₁) in FIG. 3A until the airbag 225 is in the stowed configuration shown in FIG. 3C. Once the airbag 225 is in the stowed configuration, the sleeve 230 can be wrapped around the airbag 225 in a direction indicated by fold (F₂) in FIG. 3A, and the second end portion 327 of the sleeve 230 can be releasably attached to the first flange portion 214 of the bracket 210 by a plurality of fasteners 350 (e.g., rivets, screws, etc.) as shown in FIG. 3C. As explained in further detail below, the sleeve 230 can be releasably coupled to the flange 214 by the fasteners 350 so that the sleeve 230 can be easily detached from the flange 214 upon deployment of the airbag 225.

FIGS. 4A and 4B are side views of the airbag assembly 105 attached to the structure 100 in accordance with embodiments of the present technology. FIG. 4A shows the airbag assembly 105 with the airbag 225 in the stowed configuration, and FIG. 4B shows the airbag assembly 105 with the airbag 225 in the deployed configuration. As shown in FIG. 4A, the fixed structure 100 includes a rear surface portion 406, and the component 115 (e.g., an entertainment screen) is attached to the rear surface portion 406 and defines a gap or opening (0) therebetween. The airbag assembly 105 is generally positioned above the opening (0) and includes (a) the mounting bracket 210 attached to the fixed structure 100 via the fasteners 323, 322, (b) the airbag 225 in the folded and packed configuration, and (c) the sleeve 230 disposed at least partially around the airbag 225. The airbag 225 and the first end portion 331 of the sleeve 230 are attached to the mounting bracket 210, and thus to the fixed structure 100, via the fasteners 340. Furthermore, the second end portion 327 of the sleeve 230 is releasably attached to the mounting bracket 210 via the fasteners 350. In other embodiments, the second end portion 327 of the sleeve 230 may not be attached to the mounting bracket 210 via the fasteners 350. For example, in such embodiments the second end portion 327 may be tucked between the mounting bracket 210 and the adjacent portion of the airbag 225.

The cover panel 110 can include a first edge or end portion 462 releasably attached to the mounting bracket 210 and/or the adjacent structure 100 via one or more releasable fasteners, adhesive, etc. (not shown). The cover panel 110 can further include a second edge or end portion 463 supported by a bracket 480 mounted to the rear surface portion 406. As shown in FIG. 4A, the cover panel 110 and the bracket 480 together can enclose the airbag 230. The cover panel 110 can be made of a relatively durable material, such as a hard plastic, aluminum, or combinations thereof.

As described in more detail below with reference to FIG. 4B, the cover panel 110 can be releasably attached to the mounting bracket 210 and/or the fixed structure 100 and configured to be displaced during airbag deployment so as to not impede the airbag 225 from inflating to the deployed state. In some embodiments, the cover panel 110 can be attached to the mounting bracket 210 and/or the fixed structure 100 (and/or to the sleeve 230) by a strap or tether 466 that restrains the cover panel 110 during displacement. The tether 466 can be made of a strip of flexible and/or bendable fabric material, such as nylon or other suitable materials known in the art. In some embodiments, a first end portion of the tether 466 can be attached to the mounting bracket 210, and a second, opposing end portion of the tether 466 can be attached to the cover panel 110 at or near the second end portion 463. During airbag deployment, the tether 466 can help ensure the cover panel 110 does not become a hazardous flying object to the occupant 120 (FIG. 1). In other embodiments, the first end portion 462 of the cover panel 110 can remain coupled to or near the first flange portion 214 of the mounting bracket 210 during airbag inflation, and the cover panel 110 can be configured to bend upwardly and away from the deployment path of the airbag 225 so that it does not impede the airbag 225 from inflating to the deployed state.

FIG. 4B shows the airbag system 400 with the airbag 225 inflated to the deployed configuration. As previously described, the airbag 225 can be inflated via compressed gas that is released from the inflator 252 (FIG. 2) and passes through the conduit 250 (FIG. 2) to the airbag 225. In operation, the inflating airbag 225 pushes the cover panel 110 and the second end portion 327 of the sleeve 330 away from the structure 100 and detaches the second end portion 327 of the sleeve 330 from the mounting bracket 210. The airbag 225 and the first end portion 326 of the sleeve 230 remain attached to the mounting bracket 210 during and after deployment of the airbag 225. As a result, the sleeve 330 unravels to be disposed between the airbag 225 and the opening (0) and/or the component 115. Stated differently, the sleeve 330 is positioned around the stowed airbag 225 such that deployment of the airbag 225 causes the sleeve 330 to detach from the first flange 214 of the mounting bracket 210 and cover the opening (0) and/or the component 115. By covering or otherwise extending over the opening (0) and/or the component 115, the sleeve 330 can prevent the airbag 225 or a portion thereof from inflating into or toward the opening (0) and potentially getting hung up on an edge portion of the component 115, with could undesirably impede proper inflation of the airbag 225. As shown in FIG. 4B, the tether 466 remains attached to the cover panel 110 even after deployment of the airbag 225 to prevent the cover panel 110 from flying away from the structure 100.

FIG. 4C is a top isometric view of the deployed airbag 225 of 4B. Referring to FIGS. 4B and 4C together, the deployed airbag 225 includes a rear face portion 432a facing toward the seat occupant 120 (FIG. 1), and a front face portion 432b (FIG. 4B) having a vent 434 (e.g. a hole). The vent 434 allows gas to rapidly escape from the airbag 225 after inflation. In some embodiments, the vent 434 can help limit rebound of the occupant from the airbag 225 and rapidly deflate the airbag 225 to allow egress for the occupant shortly after inflation.

Various airbag assemblies and/or associated components are described in U.S. patent application Ser. No. 13/274,659, filed Jun. 30, 2011, now U.S. Pat. No. 9,156,558, and titled INFLATABLE PERSONAL RESTRAINT SYSTEMS; U.S. patent application Ser. No. 09/143,756, filed Aug. 13, 1998, now U.S. Pat. No. 5,984,350, and titled VEHICLE SAFETY SYSTEM; U.S. patent application Ser. No. 10/672,606, filed Sep. 26, 2003, now U.S. Pat. No. 6,957,828, and titled INFLATABLE LAP BELT SAFETY BAG; U.S. patent application Ser. No. 09/253,874, filed Mar. 13, 2000, now U.S. Pat. No. 6,439,600, and titled SELF-CENTERING AIRBAG AND METHOD FOR MANUFACTURING AND TUNING THE SAME; U.S. patent application Ser. No. 09/523,875, filed Mar. 13, 2000, now U.S. Pat. No. 6,535,115, and titled AIR BAG HAVING EXCESSIVE EXTERNAL MAGNETIC FIELD PROTECTION CIRCUITRY; U.S. patent application Ser. No. 09/524,370, filed Mar. 14, 2000, now U.S. Pat. No. 6,217,066, and titled MULTIPLE INFLATOR SAFETY CUSHION; U.S. patent application Ser. No. 12/057,295, filed Mar. 27, 2008, now U.S. Pat. No. 7,665,761, and titled INFLATABLE PERSONAL RESTRAINT SYSTEMS AND ASSOCIATED METHODS OF USE AND MANUFACTURE; U.S. patent application Ser. No. 12/051,768, filed Mar. 19, 2008, now U.S. Pat. No. 7,980,590, and titled INFLATABLE PERSONAL RESTRAINT SYSTEMS HAVING WEB-MOUNTED INFLATORS AND ASSOCIATED METHODS OF USE AND MANUFACTURE; U.S. patent application Ser. No. 13/608,959, filed Sep. 10, 2012, now U.S. Pat. No. 9,276,202, and titled ELECTRONIC MODULE ASSEMBLY FOR INFLATABLE PERSONAL RESTRAINT SYSTEMS AND ASSOCIATED METHODS; U.S. patent application Ser. No. 13/270,079, filed Jun. 27, 2011, now abandoned, and titled SENSORS FOR DETECTING RAPID DECELERATION/ACCELERATION EVENTS; U.S. patent application Ser. No. 13/194,411, filed Jul. 29, 2011, now U.S. Pat. No. 8,439,398, and titled INFLATOR CONNECTORS FOR INFLATABLE PERSONAL RESTRAINTS AND ASSOCIATED SYSTEMS AND METHODS; U.S. patent application Ser. No. 13/227,392, filed Sep. 7, 2011, now U.S. Pat. No. 8,556,293, and titled BUCKLE CONNECTORS FOR INFLATABLE PERSONAL RESTRAINTS AND ASSOCIATED METHODS OF USE AND MANUFACTURE; U.S. patent application Ser. No. 13/086,234, filed Apr. 13, 2011, now U.S. Pat. No. 8,469,397, and titled STITCH PATTERNS FOR RESTRAINT-MOUNTED AIRBAGS AND ASSOCIATED SYSTEMS AND METHODS; U.S. patent application Ser. No. 13/227,382, filed Sep. 7, 2011, now U.S. Pat. No. 8,403,361, and titled ACTIVATION SYSTEMS FOR INFLATABLE PERSONAL RESTRAINT SYSTEMS; U.S. patent application Ser. No. 13/228,333, filed Sep. 8, 2011, now U.S. Pat. No. 8,818,759, and titled COMPUTER SYSTEM FOR REMOTE TESTING OF INFLATABLE PERSONAL RESTRAINT SYSTEMS; U.S. patent application Ser. No. 13/424,197, filed Mar. 19, 2012, now U.S. Pat. No. 8,523,220, and titled STRUCTURE MOUNTED AIRBAG ASSEMBLIES AND ASSOCIATED SYSTEMS AND METHODS; and U.S. Provisional Patent Application No. 62/495,602, filed Jan. 20, 2016, and titled OCCUPANT RESTRAINT SYSTEMS HAVING EXTENDING RESTRAINTS, AND ASSOCIATED SYSTEMS AND METHODS. Each of the patents and patent applications listed above is incorporated herein by reference in its entirety. Indeed, any patents and applications and other references identified herein, including any that may be listed in accompanying filing papers, are incorporated herein by reference in their entirety. Aspects of the present technology can be modified, if necessary, to employ the systems, functions, and concepts of the various references described above to provide yet further implementations of the present technology. To the extent that a portion of the present disclosure contradicts a portion of any of the above-noted patents or patent applications, the present disclosure should be used.

I/We claim:

1. An airbag assembly for use in an aircraft seating area, the airbag assembly comprising:
a mounting bracket configured to be attached to a structure in the seating area;
an airbag attached to the mounting bracket and arranged in a stowed configuration, wherein the airbag is configured to be inflated from the stowed configuration to a deployed configuration; and
a guide sleeve attached to the mounting bracket, wherein the guide sleeve at least partially surrounds the airbag in the stowed configuration, and wherein the guide sleeve is configured to unfurl between the airbag and an adjacent feature of the structure during inflation of the airbag.

2. The airbag assembly of claim 1 wherein the guide sleeve is configured to cause the airbag to follow a desired deployment path.

3. The airbag assembly of claim 1 wherein the guide sleeve is configured to unfurl between the airbag and the adjacent feature to prevent the adjacent feature from hindering deployment of the airbag.

4. The airbag assembly of claim 1 wherein the structure is a seat back, and wherein the mounting bracket is configured to be attached to the seat back proximate the adjacent feature.

5. The airbag assembly of claim 1 wherein the structure is a seat back, wherein the mounting bracket is configured to be attached to the seat back proximate a display screen mounted to the seat back, and wherein the adjacent feature is a gap between the display screen and the seat back.

6. The airbag assembly of claim 1 wherein the structure is a partition positioned forward of a passenger seat, and wherein the mounting bracket is configured to be attached to the partition proximate the adjacent feature.

7. The airbag assembly of claim 1 wherein the structure is a partition positioned forward of a passenger seat, wherein the mounting bracket is configured to be attached to the partition proximate a display screen mounted to the partition, and wherein the adjacent feature is a gap between the display screen and the partition.

8. The airbag assembly of claim 1 wherein the guide sleeve and the airbag are attached to the mounting bracket via a plurality of fasteners extending through an end portion of the airbag and an end portion of the sleeve.

9. The airbag assembly of claim 7 wherein the end portion of the sleeve is a first end portion, wherein the sleeve further includes a second end portion opposite the first end portion, wherein the first end portion is attached to the mounting bracket at a first location, and wherein the second end portion is releasably attached to the mounting bracket at a second location, spaced apart from the first location.

10. The airbag assembly of claim 1, further comprising:
an inflator;
a conduit having a first end portion operably coupled to the airbag and a second end portion operably coupled to the inflator; and
an electronics assembly operably connected to the inflator, wherein the electronics assembly is configured to transmit a signal to the inflator in the event of a rapid deceleration event, and wherein the inflator is configure to respond to the signal by releasing high pressure gas into the airbag via the conduit.

11. A system comprising:
an aircraft passenger seat;
a component attached to the passenger seat; and
an airbag assembly, the airbag assembly including—
a mounting structure attached to the passenger seat;
an airbag attached to the mounting structure and configured to be inflated from a stowed configuration to a deployed configuration; and
a guide sleeve attached to the mounting structure, wherein the guide sleeve at least partially surrounds the airbag in the stowed configuration, and wherein the guide sleeve is configured to extend between the airbag and the component when the airbag is inflated to the deployed configuration.

12. The system of claim 11 wherein the component is attached to a rear portion of the passenger seat, and wherein the airbag is positioned above the component when the airbag is in the stowed configuration.

13. The system of claim 12 wherein the component is a display screen, and wherein the airbag is configured to inflate so that the display screen is positioned between the deployed airbag and the passenger seat.

14. The system of claim 11 wherein the component defines an opening between a surface of the passenger seat and the component, and wherein the guide sleeve is configured to cover the opening during inflation of the airbag to the deployed configuration.

15. The system of claim 11 wherein the component is a display screen mounted to a rear portion of the passenger seat.

16. The system of claim 11 wherein the component is a tray table movably coupled to a rear portion of the passenger seat.

17. The system of claim 11 wherein the guide sleeve substantially encloses the airbag in the stowed configuration.

18. The system of claim 11, further comprising a cover panel removably attached to the passenger seat and covering the airbag when the airbag is in the stowed configuration.

19. The system of claim 11 wherein the airbag and the guide sleeve are attached to the mounting structure via one or more coupling members that extend through an end portion of the airbag and an end portion of the guide sleeve.

20. A method of deploying an airbag from a recess on an aircraft passenger seat, wherein the airbag is stowed above a component mounted to the passenger seat, and wherein the method comprises:
rapidly inflating the airbag to deploy the airbag from the recess in response to a rapid deceleration event; and
in response to inflating the airbag, unfurling a guide sleeve from a first position wrapped around the airbag to a second position between the airbag and the component

21. The method of claim 20 wherein the component defines an opening adjacent to the stowed airbag, and wherein unfurling the guide sleeve includes positioning the guide sleeve over the opening to prevent the airbag from deploying therein.
